(19) United States
(12) Patent Application Publication
(10) Pub. No.: US 2014/0061253 A1
(43) Pub. Date: Mar. 6, 2014

(54) LIQUID DISPENSER CONTAINERS

(71) Applicant: Steven L. Sweeton, Lake Winnebago, MO (US)

(72) Inventor: Steven L. Sweeton, Lake Winnebago, MO (US)

(73) Assignee: MEADWESTVACO CALMAR, INC., Richmond, VA (US)

(21) Appl. No.: 14/114,974

(22) PCT Filed: May 3, 2012
(86) PCT No.: PCT/US12/36315

§ 371 Date: Oct. 31, 2013

Related U.S. Application Data
(60) Provisional application No. 61/481,871, filed on May 3, 2011.

(51) Int. Cl. B67D 7/58

(52) U.S. Cl. CPC B05B 11/3042
USPC 222/382; 220/669

(57) ABSTRACT

According to certain embodiments of the invention, a dispensing device may include a pump system having a large, angled spout allowing the downward dispensing of a product into a wash basin or other delivery area. The dispensing device may also include a bottle or container handle having an angle on an interior of the bottle or container such that a dip tube used with the pump system may be forced into a particular portion or location within the bottle or container. The dispensing device may also include a wide, ergonomic actuator which may be actuated by the palm of a hand or a thumb as a user grips a bottle or container to which a pump system is attached and to which the actuator is in communication for actuating the pump system.

### CROSS-REFERENCE TO RELATED APPLICATIONS

This application claims the benefit of, and priority to, U.S. Provisional Application No. 61/481,871, entitled “LIQUID DISPENSERS AND METHODS FOR MAKING THE SAME,” filed 3 May 2011, and incorporates the same herein by reference in its entirety.

### BACKGROUND OF THE INVENTION

1. Field of the Invention

Embodiments of the invention relate generally to containers for use with liquid dispensers and dispensing systems and more particularly to containers including one or more integrated openings or dip tube guides.

2. State of the Art

Liquid dispensers come in all shapes and sizes and are used for dispensing a variety of liquids. Dispensers and dispensing devices used in the laundry care markets are typically large bottles having a gravity fed valve or a pour spout. Such dispensing devices are often cumbersome and difficult to use due to the size of the bottle and forces required to either pour or dispense the product from the dispensing device. As a result, there is a demand for dispensing devices which offer alternatives to the current devices. There is also a demand for devices which allow a user to operate a dispenser with one hand.

In addition, may liquid dispensers employ the use of a dip tube to transport fluid or product from within a container to a pump system so that the fluid or product may be removed from the interior of the container. In many instances, a dip tube may be cut, shaped, or deformed such that the dip tube is unable to evacuate all of a product from a container. For example, in some containers, low points in the bottom of the container may hold or retain fluid such that the dip tube may not be capable of reaching the fluid for evacuation. In other instances, a user may tip a liquid dispenser such that fluid moves to the front or back of a container, out of the reach of a dip tube. This may result in a loss of prime or inability to pump all of the fluid from a container.

In an effort to alleviate problems with dip tubes, various solutions have been adopted. For instance, U.S. Pat. No. 5,279,450 proposes the use of a partition within a bottle to direct a dip tube to the front of the bottle for evacuation. While use of such a system may be beneficial, the location of the partition with respect to the opening in the bottle may complicate the filling process and attachment of a pump system to such bottle. Similarly, U.S. Pat. No. 5,875,940 discloses a dip tube guide integrated into a container such that the dip tube guide allows a dip tube to be positioned for maximum extraction of a product from a bottle. However, the positioning of the dip tube guide complicates filling and placement of the dip tube and pump system onto a bottle. U.S. Pat. No. 6,059,152 also discloses a dip tube guide.

While various solutions and configurations for guiding a dip tube have been proposed, there remains a need for a solution which allows easy filling, assembly of a pump system to the bottle or container, and ease of use for a user.

### BRIEF SUMMARY OF THE INVENTION

According to certain embodiments of the invention, a dispensing device may include a pump system having a large, angled spout allowing the downward dispensing of a product into a wash basin or other delivery area. The dispensing device may also include a bottle or container handle having an angle on an interior of the bottle or container such that a dip tube used with the pump system may be forced into a particular portion or location within the bottle or container. The dispensing device may also include a wide, ergonomic actuator which may be actuated by the palm of a hand or a thumb as a user grips a bottle or container to which a pump system is attached and to which the actuator is in communication for actuating the pump system.

According to other embodiments of the invention, a dispensing device may include a pump system mounted on a bottle or other container such as a pouch. The pump system may include an integrated actuator and handle wherein a leaf-spring or other integrated spring facilitates movement of the actuator with respect to the handle. The integrated handle and actuator may include an integrated connector capable of attaching to a bottle or other container through mechanisms such as a screw closure or a bayonet type closure. In other embodiments, a connector may be paired with the integrated handle and actuator to connect it to a bottle or container.

According to certain embodiments of the invention, a container to which a pump system may be attached may include one or more dip tube guides formed in the container. In some embodiments, the one or more dip tube guides may be formed as openings through the container such that the dip tube guide may also serve as a handle or grip to facilitate transport or use of a dispensing device.

In still other embodiments of the invention, a dip tube guide integrated with a container may be positioned in such a manner to promote the most efficient placement of a dip tube in the container for operation. In some embodiments, the container may also include a front or rear edge that is convex or is shaped to receive an end of a dip tube as it is directed by the dip tube guide.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates a dispensing device according to various embodiments of the invention;

FIG. 2 illustrates a dispensing device according to various embodiments of the invention;

FIG. 3 illustrates a dispensing device according to various embodiments of the invention; and

FIG. 4 illustrates a container according to various embodiments of the invention;

FIG. 5 illustrates a perspective view of a container according to various embodiments of the invention;

FIG. 6 illustrates a perspective view of a container according to various embodiments of the invention;

FIG. 7 illustrates a top-down view of a container according to various embodiments of the invention;

FIG. 8 illustrates a front view of a container according to various embodiments of the invention;

FIG. 9 illustrates a rear view of a container according to various embodiments of the invention;

FIG. 10 illustrates a bottom view of a container according to various embodiments of the invention; and

FIG. 11 illustrates a dispensing device according to various embodiments of the invention.

### DETAILED DESCRIPTION OF THE INVENTION

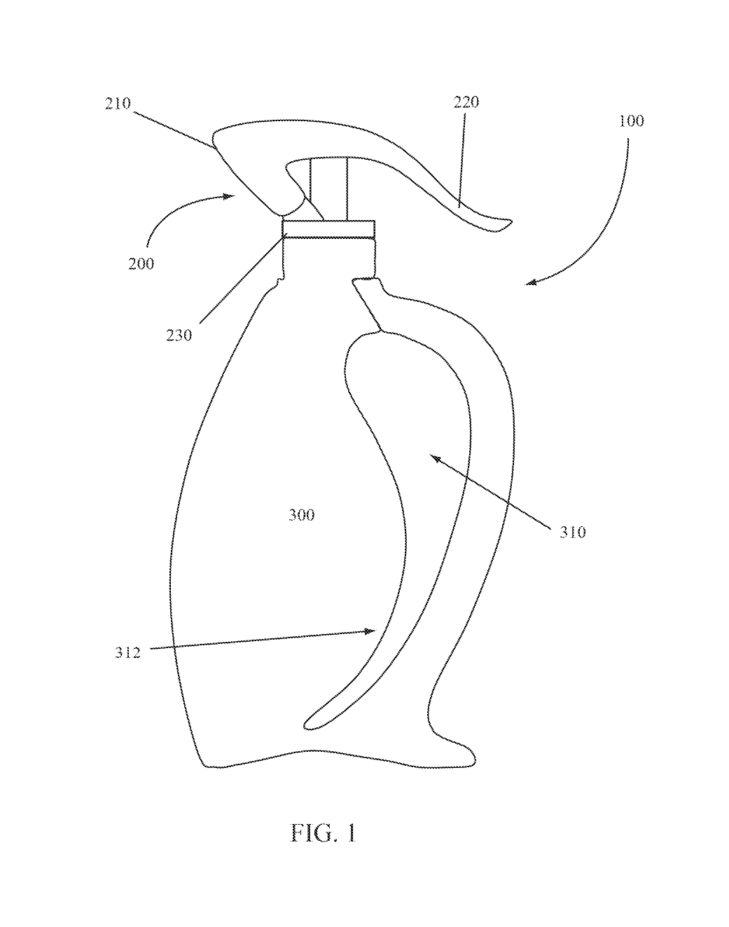

According to various embodiments of the invention, a dispensing device 100 may include a pump system 200 in communication with a container 300, such as the bottle illustrated in FIG. 1. While the container 300 illustrated in FIG. 1 is a bottle, it is understood that various embodiments of the invention may include other containers such as pouches or the like.

According to some embodiments of the invention, a pump system 200 may include a connector 230, an actuator 220 and a spout 210 in communication with a pump. For example, a dispensing device 100 according to embodiments of the invention is illustrated in FIG. 1. While a pump is not specifically illustrated, any conventional pump may be used with embodiments of the invention and the pump system 200 may be attached to or otherwise put in communication with a pump according to customary practice. For example, a pump having an accumulator, a piston, a dip tube, and an inlet and outlet may be mounted to or connected to the pump system 200 such that upon actuation of the actuator 220, product is pumped from an interior of the container 300 through the pump and out the spout 210 of the pump system 200.

As illustrated in FIG. 1, a container 300 may include an opening 310 or hole through the container 300 which may facilitate griping of the container 300 by a user. According to certain embodiments of the invention, a user may grip the container 300 illustrated in FIG. 1 through the opening 310 such that their thumb or finger may rest on a portion of the actuator 220. Application of a downward force on the actuator 220 may actuate the pump, allowing product to flow from an interior of the container 300, through the pump system 200, and out a spout 210. The positioning, design, and shape of the opening 310 in the container 300 in relation to the position of the actuator 220 of the pump system 200 may be tailored or customized such that a user may carry, use, and actuate the dispensing device 100 using one hand. In addition, the distance between the container 300 and the actuator 220 may be tailored or customized to improve the dispensing stroke and volume of product pumped.

For example, according to various embodiments of the invention, the distance between the container 300 and the actuator 210 may range from between about 0 inches to about 5 inches. In other embodiments, the distance may vary between about 1 inch and about 5 inches. In other embodiments of the invention, the distance between the container 300 and actuator 220 may be customized based on the output size of a pump used with the pump system 200 such that the output through one stroke of the actuator 220 is up to about 100 mL.

According to some embodiments of the invention, a container 300 may also include a sloped interior wall 312. The sloped interior wall 312 may be sloped in such a way that upon insertion of a dip tube used with a pump in a pump system 200, the dip tube may contact the sloped interior wall 312 and be directed to a location within the container 300 from which a product is to be collected. The positioning of the dip tube using a sloped interior wall 312 may assist with complete or maximized evacuation of a product from a container 300. For example, the container 300 illustrated in FIG. 1 includes a sloped interior wall 312 which will guide a dip tube towards a front portion of the container 300 or that portion in-line with the spout 210 as illustrated.

According to certain embodiments of the invention, a spout 210 may be angled in a downward direction as illustrated in FIG. 1. A downward angle of the spout 210 may facilitate the dispensing of a product from the pump system 200 towards a wash basin or other desired area.

A connector 230 according to embodiments of the invention may include any type of connecting device used to secure a pump or pump system 200 to a container 300. For example, a connector 230 may include a screw-type closure, a bayonet-type closure, a snap-fit closure, or other convention closure mechanism or system.

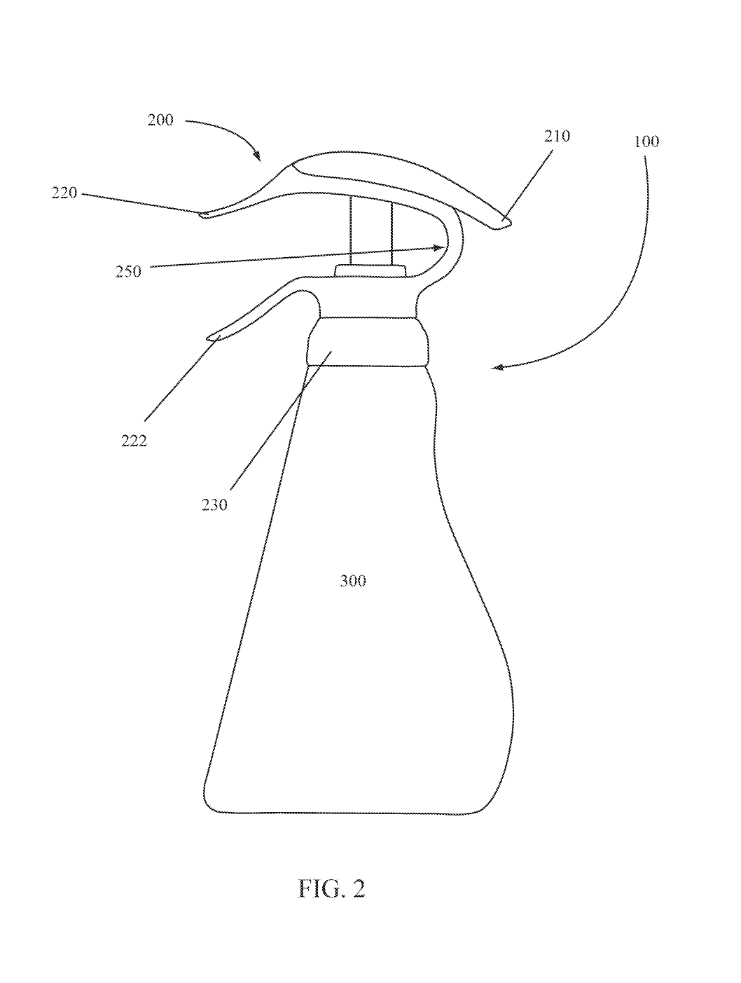

A dispensing device 100 according to other embodiments of the invention is illustrated in FIG. 2. A dispensing device 100 may include a container 300 connected to a pump system 200. The pump system 200 may include an actuator 220, a handle 222 and a spring 250. According to certain embodiments of the invention, the actuator 220 and handle 222 may be integrated with the spring 250 such that the handle 222, spring 250 and actuator 220 form a single component. A connector 230 may secure the pump system 200 to a container 300. A spout 210 may direct the output of product pumped through a pump attached to the pump system 200.

According to some embodiments of the invention, a spring 250 may include a leaf-spring. In certain embodiments, a spring 250 may include a circular or elliptical curve. In still other embodiments, a spring 250 may include multiple arms or segments such that the spring 250 need not be formed of a solid piece but may include openings or holes through at least a portion of the spring 250.

During operation, the handle 222 of the pump system 200 illustrated in FIG. 2 may be gripped by a user. The actuator 220 may then be actuated by the user's thumb. The spring 250 may flex with the application of force to the actuator 220 causing actuation of the actuator 220. Upon release of an actuation force, the spring 250 may return the actuator 220 to a non-actuated position. The configuration illustrated in FIG. 2 may allow a user to easily grip and actuate the dispensing device 100 using one hand.

According to various embodiments of the invention, an integrated handle 222, spring 250 and actuator 220 may be made of polyolefin. In other embodiments of the invention, the integrated handle 222, spring 250, and actuator 220 may be made of polypropylene. In still other embodiments of the invention, other plastics or resins may be used to form or mold components of the pump system 200.

According to various embodiments of the invention, a distance between the handle 222 and actuator 220 may be customized or tailored to an intended application. In some embodiments, the distance between an outer point of the actuator 220 and outer point of the handle 222 may be between 0 inches and about 5 inches. In other embodiments it may be between about 1 inch and about 5 inches.

In some embodiments of the invention, the output of the pump system 200 may also be tailored or customized to provide a desired output relative to the actuation stroke length between the handle 222 and actuator 220. For example, in certain applications, it may be desirable to customize a pump capacity and stroke length to provide an output of up to 100 mL or more of product.

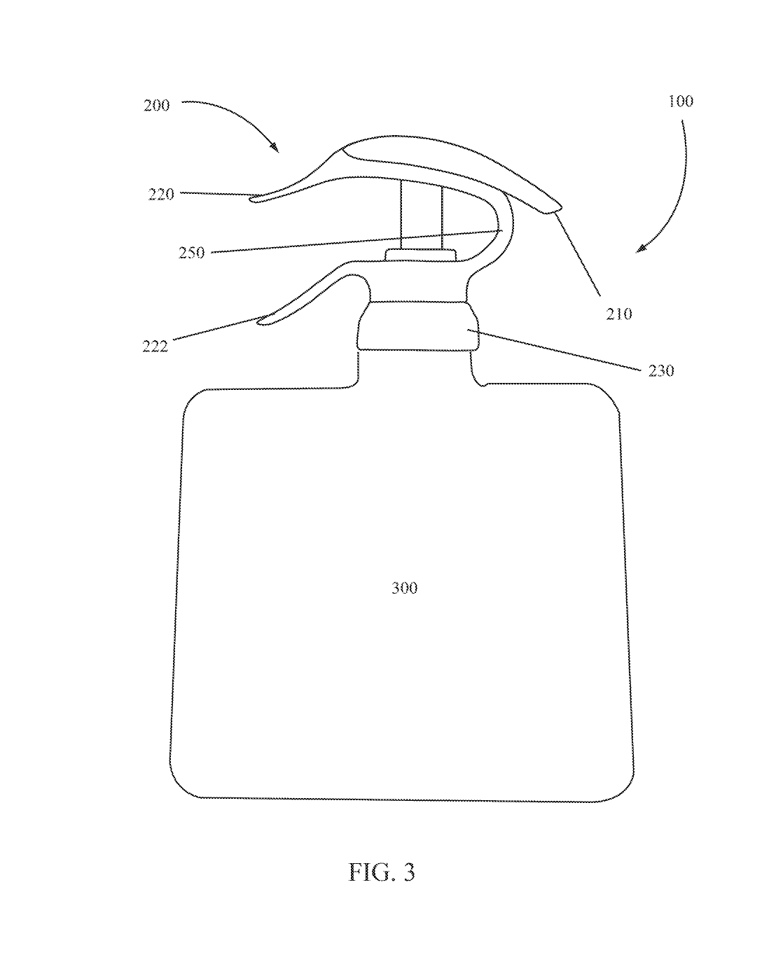

A dispensing device 100 according to still other embodiments of the invention is illustrated in FIG. 3. As illustrated, a pump system 200 similar to that illustrated in FIG. 2 may be attached to or connected to a container 300, wherein the container is a flexible pouch.

Dispensing devices 100 according to various embodiments of the invention may be used with liquid products. In some embodiments, a dispensing device 100 may be customized to be used with a laundry product such as laundry detergent. The pump system 200 may be configured to dispense a particular dosage of liquid as desired and the spout 210 configuration and actuator 220 configuration may be customized for the user or for the application for which the dispensing device 100 is to be used.

A container according to various embodiments of the invention is illustrated in FIG. 4. As illustrated, a container 300 may include an opening 310 or hole through the container 300. The opening 310 may be sloped and configured to guide a dip tube into a front portion of the container 300 when a pump system 200 is assembled with the container 300. In some embodiments of the invention, an opening 310 through the container 300 may be large enough to allow a user to fit one or more fingers through or at least partially into the opening 310 to allow the user to carry or grip the container 300 using such opening 310. In some embodiments, an edge 313 of an opening 310 may be rounded to as to provide a comfortable surface for carrying the container 300 or using the container 300 with a pump system 200. In still other embodiments of the invention, the opening 310 may not pass completely through the container 300 and may instead be configured as a “pinch-off” wherein an opening through the container 300 is not formed but depressions in the container 300 are formed.

According to various embodiments of the invention, the opening 310 may define a sloped interior wall 312 within the container 300 against which a dip tube will interact upon insertion into the container 300. The sloped interior wall 312 may be sloped, shaped, or designed to position a dip tube in a desired location within the container 300.

According to various embodiments of the invention, an opening 310 in a container 300 may define a bottom portion of the sloped interior wall 312 aligned a certain distance from the center line of a container 300. For example, as illustrated in FIG. 4, the front edge of the sloped interior wall 312 may extend forward the center line of the container 300 by a distance Dh. In addition, the top of the front edge of the sloped interior wall 312 may extend a distance Dv above the bottom of the container 300. Furthermore, the opening 310 may define the sloped interior wall 312 such that the sloped interior wall spans both the front and rear portion of the container 300 relative to the center line of the container 300.

In some embodiments of the invention, the distance “Dh” may be between about 0.0 cm to about 8 cm or more. The distance “Dh” may be customized to position a dip tube 290 as desired.

In various embodiments of the invention, the distance “Dv” may be between about 0.0 cm and about 7.6 cm or more. In certain embodiments, a distance “Dv” of about 7.6 cm may be preferred.

According to various embodiments of the invention, the positioning of the sloped interior wall 312 in front of the center line and to a rear of the center line may facilitate proper placement of a dip tube within the container 300. For instance, if on a filling line a dip tube 290 is inserted into the container mouth as a pump system 200 is assembled to the container 300 or attached to a connector 320, the dip tube 290 may be inserted at an angle. As the dip tube 290 is inserted, the positioning of the interior sloped wall 312 behind the center line of the container 300 may facilitate the positioning of the dip tube 290 by guiding the dip tube to a front portion of the container 300. In addition, positioning of a sloped interior wall 312 near the upper end of the container 300—or near the mouth of the container—may help ensure that the dip tube 290 is properly guided, preventing instances where the dip tube may be directed rearward of the sloped interior wall 312.

In some embodiments of the invention, a space 315 may exist between the rear wall of the opening 310 and a rear wall of the container 300 as illustrated in FIG. 4.

While a screw-type connector 320 is shown on the container 300 illustrated in FIG. 4, it is understood that different connectors 320 may be used with various embodiments of the invention. For example, if a pump system 200 having a bayonet connection is to be assembled to a filled container 300, the container 300 may include a bayonet-type connector 320. Other connections and connectors 320 as known may also be used with various embodiments of the invention.

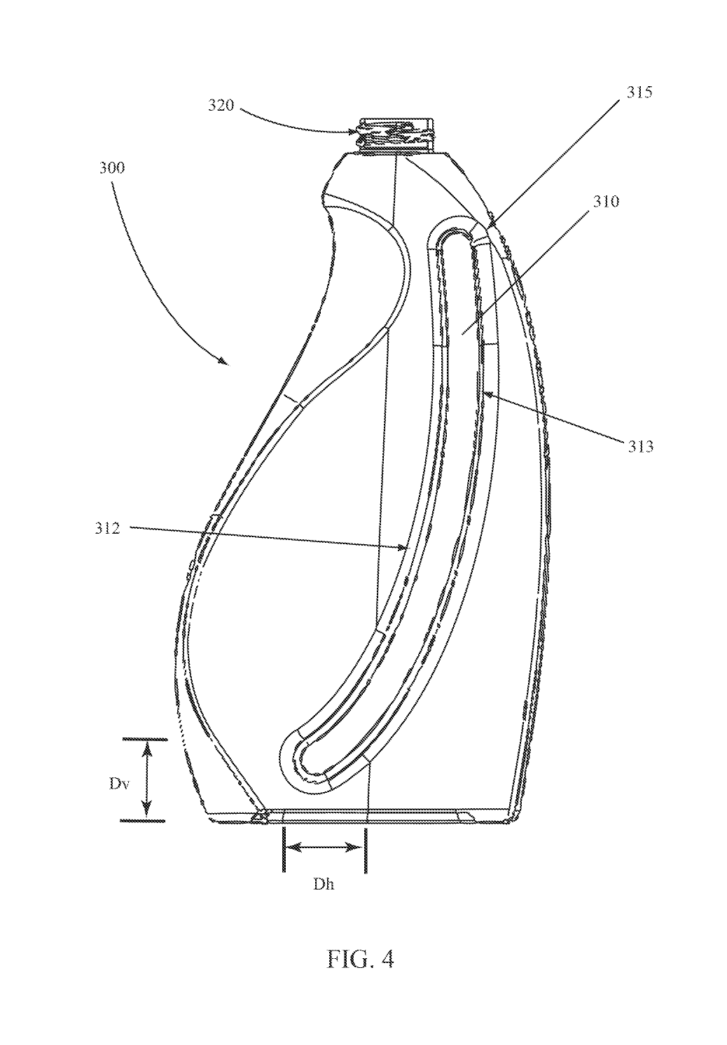

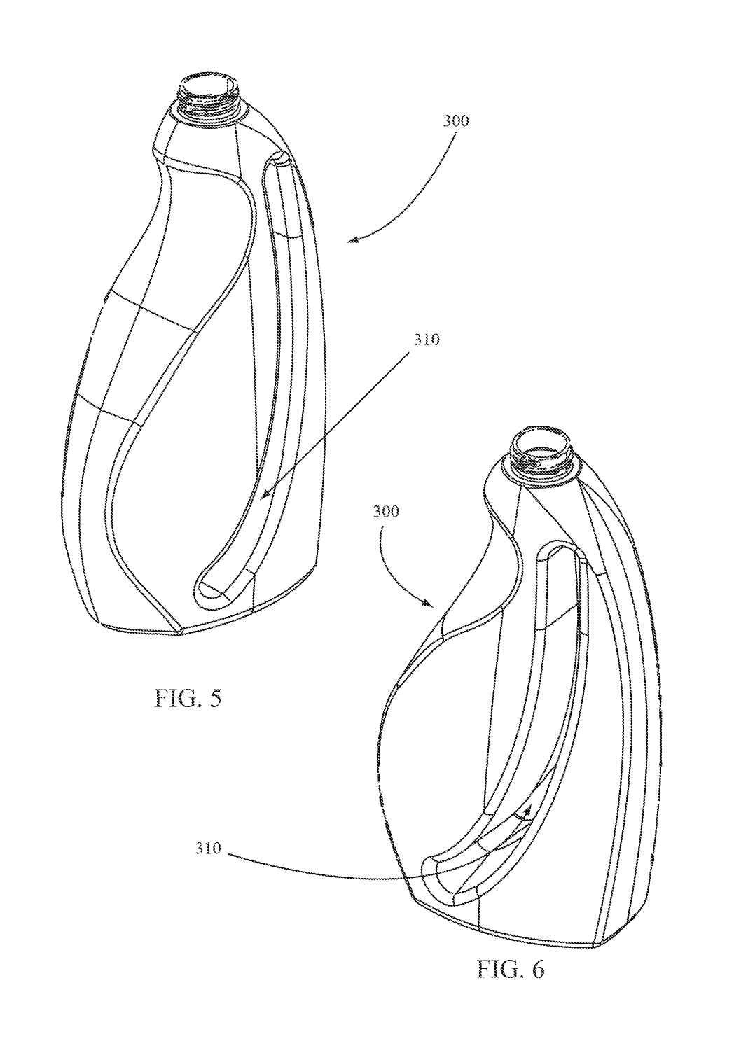

Perspective views of a container 300 according to various embodiments of the invention are illustrated in FIGS. 5 and 6.

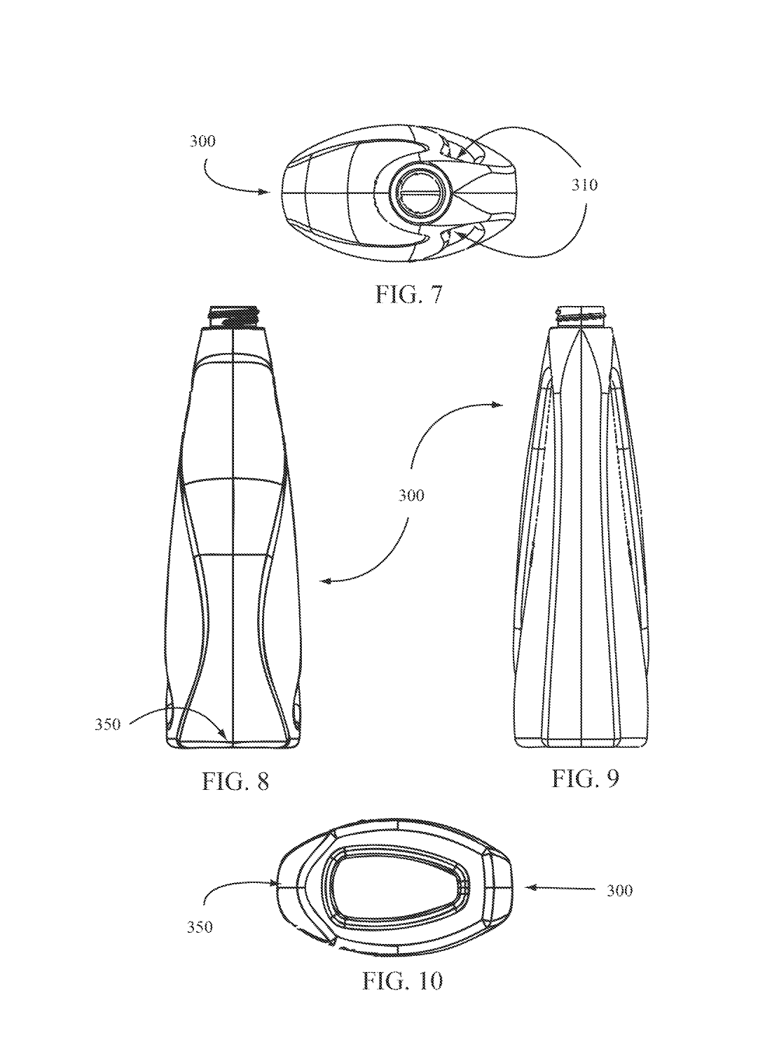

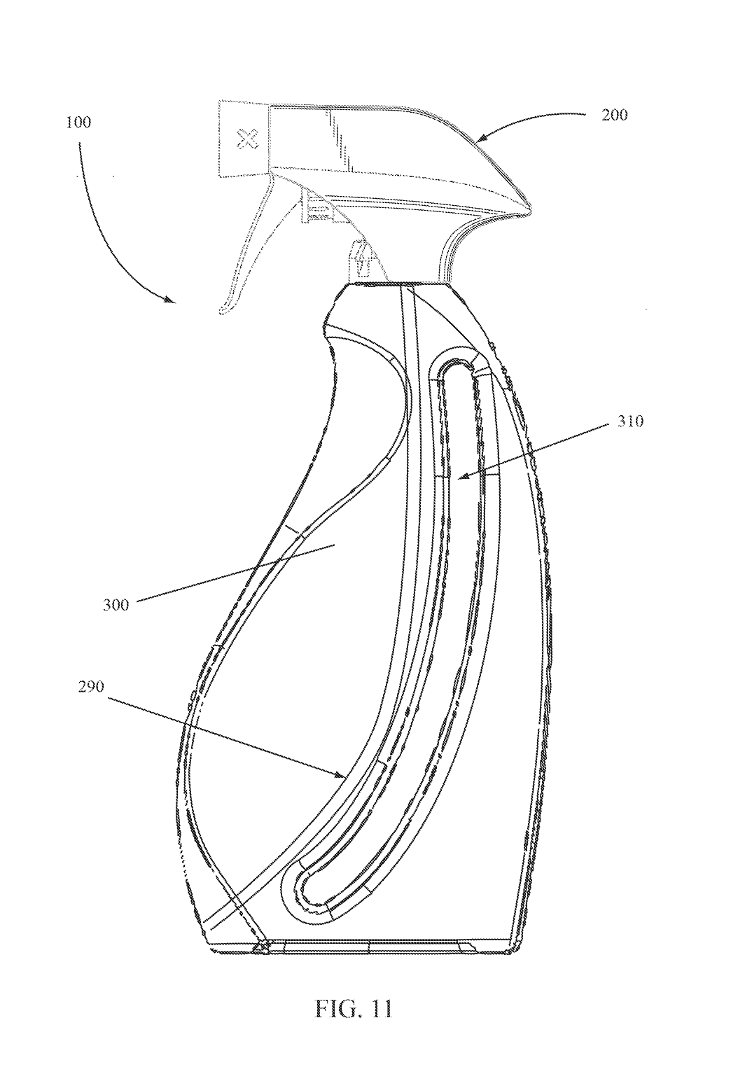

FIGS. 7 through 10 illustrate top, front, rear, and bottom views of a container 300 according to various embodiments of the invention, respectively. As illustrated in FIGS. 8 and 10, a container 300 may include a depression, convex area, or shaped region 350 in a front portion of the container 300. The depression, convex area, or shaped region 350 may be configured to facilitate complete or near complete evacuation of the container 300. For example, the depression, convex area, or shaped region 350 may be configured such that a dip tube 290 is guided into that region by the sloped interior wall 312 and product is guided into the same region for evacuation.

A dispensing device 100 according to various embodiments of the invention is illustrated in FIG. 11. As shown, a dispensing device 100 may include a pump system 200 attached to a container 300. The pump system 200 may include a trigger sprayer as illustrated. In other embodiments, a different type of pump system 200 may be used. The pump system 200 may also include one or more dip tubes 290 extending from the trigger sprayer into the container 300. As illustrated, a sloped interior wall 312 of the container 300 may guide the dip tube 290 into a front portion of the container 300. An opening 310 or hole in the container 300 may form both the sloped interior wall 312 for guiding the dip tube 290 during filling or assembly and a location for a user to grip or support the dispensing device 100 during use or transport. In various embodiments, the opening 310 may be configured to facilitate use of the trigger sprayer or dispensing device 100.

Containers 300 according to various embodiments of the invention may be blow molded, molded, or otherwise formed of a plastic material or other suitable material. Other materials and methods for making containers 300 of the present invention may also be used.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A dispensing device, comprising:
a container, comprising:
an opening in the container;
a sloped interior wall with an interior of the container defined by the opening;
wherein the sloped interior wall bisects the center line of the container; and
a pump system attached to the container.

2. The dispensing device of claim 1, wherein the sloped interior wall comprises a front edge a distance Dh from the centerline of the container, wherein the distance Dh is between about 0.0 cm and about 8 cm.

3. The dispensing device of claim 1, wherein the sloped interior wall comprises a top of a front edge a distance Dv from the centerline of the container, wherein the distance Dv is between about 0.0 cm and about 7.6 cm.

4. The dispensing device of claim 1, wherein the container further comprises a space between the rear wall of the opening and a rear wall of the container.

5. The dispensing device of claim 1, wherein the opening in the container further comprises rounded edges.

6. The dispensing device of claim 1, wherein the opening is configured to allow a user to grasp the container through the opening.

7. The dispensing device of claim 1, wherein the container further comprises a shaped region in a front portion of the container.

8. The dispensing device of claim 1, wherein the container further comprises a shaped region in a front portion of the container and wherein the interior sloped wall is configured to guide a dip tube into the shaped region.

9. The dispensing device of claim 1, wherein the pump system further comprises a trigger sprayer and a dip tube.

10. The dispensing device of claim 1, wherein the pump system further comprises a finger pump and a dip tube.

11. A container, comprising:
a container mouth;
an opening through a portion of the container; and
a sloped interior wall with an interior of the container defined by the opening.

12. The container of claim 11, wherein the sloped interior wall comprises a front edge a distance Dh from the centerline of the container, wherein the distance Dh is between about 0.0 cm and about 8 cm.

13. The container of claim 11, wherein the sloped interior wall comprises a top of a front edge a distance Dv from the centerline of the container, wherein the distance Dv is between about 0.0 cm and about 7.6 cm.

14. The container of claim 11, wherein the container further comprises a space between the rear wall of the opening and a rear wall of the container.

15. The container of claim 11, wherein the opening in the container further comprises rounded edges.

16. The container of claim 11, wherein the opening is configured to allow a user to grasp the container through the opening.

17. The container of claim 11, wherein the container further comprises a shaped region in a front portion of the container.

18. The container of claim 11, wherein the container further comprises a shaped region in a front portion of the container and wherein the interior sloped wall is configured to guide a dip tube into the shaped region.
